(19) United States
(12) Patent Application Publication
(10) Pub. No.: US 2015/0035179 A1
(43) Pub. Date: Feb. 5, 2015

(54) LIQUID ATOMIZATION DEVICE

(71) Applicant: Nozzle Network Co., Ltd., Tamba-shi, Hyogo (JP)

(72) Inventors: Hiroyoshi Asakawa, Tamba-shi (JP); Ryota Kuge, Tamba-shi (JP)

(21) Appl. No.: 14/355,823

(22) PCT Filed: Oct. 19, 2012
(86) PCT No.: PCT/JP2012/077075

§ 371 Date: Jun. 24, 2014

(30) Foreign Application Priority Data
Nov. 2, 2011 (JP) 2011-241330

(51) Int. Cl. B01F 3/04; B05B 7/00; B01F 5/04

(52) U.S. Cl. CPC B01F 3/04063; B01F 5/04; B05B 7/0012
USPC 261/76

(57) ABSTRACT

A liquid atomization device includes a first gas spray unit and a second gas spray unit; a liquid outflow unit for flowing out liquid; a gas-liquid mixing area where a gas flow sprayed from the first gas spray unit, a gas flow sprayed from the second gas spray unit, and liquid which flows out from the liquid outflow unit are made to collide against each other to atomize the liquid; a projection formed to project out of the device such that its cross section projects in a convex manner, the gas-liquid mixing area being formed in the projection; a spray slit formed in the projection along a wide angle spray direction of mist produced by the gas-liquid mixing area; and a restriction portion formed near a bottom of the spray slit such that the restriction portion inclines in the wide angle spray direction of the mist.

### TECHNICAL FIELD

The present invention relates to a liquid atomizing device and a liquid atomizing method for atomizing liquid.

### BACKGROUND ART

As conventional atomizing technique, there are a gas-liquid mix type (two-fluid type) technique, an ultrasound type technique, an extra-high voltage type (100 MPa to 300 MPa) technique, and a steaming type technique. According to a general two-fluid nozzle, gas and liquid are injected in the same injection direction, and liquid is miniaturized by a shear effect generated by accompanying flow of gas and liquid.

As one example of a gas-liquid mix type two-fluid nozzle, an atomizing nozzle device for producing minute particle mist is known (patent document 1). This atomizing nozzle device includes a first nozzle portion and a second nozzle portion, atomized liquid from the first nozzle portion and atomized liquid from the second nozzle portion are made to collide with each other, and minute particle mist can be formed. However, since the atomizing nozzle device includes two two-fluid nozzle portions, the atomizing nozzle device becomes expensive and this is not suitable for miniaturization.

### PRIOR ART DOCUMENTS

### Patent Documents

In the case of the conventional nozzle structure, if a spray angle is a wide angle (e.g., 80° or more), there is a problem that its spray flow adheres to a spray outlet to become dew, and the dew drips and wets a periphery.

### PRIOR ART DOCUMENT

### Patent Document

Patent Document 1: JP-A-2002-126587

### SUMMARY OF THE INVENTION

### Problem to be Solved by the Invention

It is an object of the present invention to provide a liquid atomizing device and a liquid atomizing method capable of atomizing liquid with a simple device configuration using a new principle which is different from the miniaturization principle of the above-described prior art.

### Means for Solving the Problems

A liquid atomization device of the present invention includes:

a first gas spray unit and a second gas spray unit for causing two gas flows collide against each other;

a liquid outflow unit for flowing out liquid;

a gas-liquid mixing area where a gas flow sprayed from the first gas spray unit, a gas flow sprayed from the second gas spray unit, and liquid which flows out from the liquid outflow unit are made to collide against each other to atomize the liquid;

a projection formed to project out of the device such that its cross section projects in a convex manner, the gas-liquid mixing area being formed in the projection;

a spray slit formed in the projection along a wide angle spray direction of mist produced by the gas-liquid mixing area; and

a restriction portion formed near a bottom of the spray slit such that the restriction portion inclines in the wide angle spray direction of the mist.

A working effect of this configuration will be described with reference to FIGS. 1A to 1C (schematic sectional views of atomization area). Gas flows 11 and 21 sprayed from first and second gas spray units 1 and 2 collide against each other, and a collision portion 100 is formed. A portion including this collision portion 100 is called a collision wall (FIG. 1B). Liquid 61 which flows out from a liquid outflow unit 6 collides against this collision wall (including collision portion 100) (FIG. 1B). If the liquid 61 collides against the collision wall, the liquid 61 is crushed (atomized) and becomes mist 62. An area where the mist 62 is generated is shown by a broken line as a gas-liquid mixing area 120. The mist 62 widely spreads (like a fan) from a gap of a spray slit 31 formed between projections 30 and is sprayed (see FIGS. 2A and 2B). At this time, restriction portions 32a and 32b are formed in the vicinity of a bottom of the spray slit 31 toward a wide angle spray direction (see FIG. 1C). By the restriction portions 32a and 32b, mist does not adhere to a nozzle tip end surface and is easily sprayed forward, dew is less likely to be generated on a nozzle tip end portion even if the mist is widely sprayed, and average particle diameters in a spray pattern long diameter direction are substantially equalized.

The restriction portions 32a and 32b may be formed such that their tip ends or inclined surfaces project outward (in spray direction) of an end of a recessed groove cross section of the spray slit 31. The restriction portions 32a and 32b may be formed outward (in spray direction) of a recessed groove interior (or projections 30) of the spray slit 31.

In the present invention, the projections may be integrally formed on a member which forms a gas orifice, or may be formed separately from such a member.

According to the liquid atomizing device of the invention, liquid flow and the collision portion or the collision wall (including the collision portion) of the gas flows are made to collide with each other and pulverized. According to this collision, it is possible to efficiently atomize under a low pressure (low gas pressure, low liquid pressure) at low flow rate (low gas flow rate, low liquid flow rate) with low energy and efficiently. As compared with the conventional two-fluid nozzle, it is possible to atomize with low gas-liquid volume ratio (or gas-liquid ratio). As compared with the conventional two-fluid nozzle, the liquid atomizing device of the invention has lower noise. A structure of the liquid atomizing device of the invention can be simplified.

Although a pressure and a flow rate of gas (gas flow) injected from the gas injection portion are not especially limited, it is possible to suitably atomize liquid under a low gas pressure at a low gas flow rate by the atomizing principle of the invention. It is preferable that pressures of gases which configure the collision portion and the collision wall are set equal to or substantially equal to each other, and it is preferable that flow rates of gases (gas-flows) configuring the collision portion and the collision wall are set equal to or substantially equal to each other. A cross sectional shape of gas-flow injected from the gas injection portion is not especially limited, and it is possible to employ a circular shape, an oval shape, a rectangular shape and a polygonal shape. It is preferable that cross sectional shapes of gases (gas-flows) which configure the collision portion and the collision wall are equal to or substantially equal to each other. It is preferable that a collision portion having a constant shape and a constant size is maintained by suppressing deformation and size reduction of the collision portion, so that an atomized body having a stable atomizing amount and small change in particle diameter is produced.

Although a pressure and a flow rate of liquid (liquid-flow) flowed out from the liquid outflow portion are not especially limited, it is possible to suitably atomize liquid having a low pressure and a low flow rate by the atomizing principle of the invention. A pressure of the liquid injection portion may be a water pressure in a general water pipe, and the liquid outflow portion may be a device which makes liquid drop naturally. In this invention, concerning an expression “liquid flowed out by the liquid outflow portion”, liquid which drops at a natural dropping speed is included in the “flowed-out liquid”.

Relative arrangement examples of the liquid outflow portion and the gas injection portion will be described with reference to FIGS. 3A to 3F. By the relative arrangements, a gas-liquid collision position is determined. According to the arrangement shown in FIG. 3A, the first and second gas injection portions 1 and 2 are opposed to each other, and a nozzle tip end of the liquid outflow portion 6 is in contact with outer side surfaces of both nozzle tip ends of the first and second gas injection portions 1 and 2. According to the arrangement shown in FIG. 3B, the first and second gas injection portions 1 and 2 are opposed to each other, and both the nozzle tip ends of the first and second gas injection portions 1 and 2 and the nozzle tip end of the liquid outflow portion 6 are in contact with each other. In the arrangement of FIG. 3B, there is a tendency that a flow rate of liquid which flows out is greater and backflow is smaller than that of the arrangement of FIG. 3A. According to the arrangement shown in FIG. 3C, a nozzle of the liquid outflow portion 6 enters between both the nozzle tip ends of the first and second gas injection portions 1 and 2. According to the arrangement shown in FIG. 3D, a distance between both the nozzles of the first and second gas injection portions 1 and 2 is greater than that of FIG. 3B. According to the arrangement shown in FIG. 3E, the liquid outflow portion 6 is far from the collision wall as compared with FIG. 3B. Although the number of liquid outflow portion is one, the number thereof may be two or more, and two liquid outflow portions are disposed in FIG. 3F. The member such as the projection and others are omitted in FIGS. 3A to 3F.

The produced mist is injected together with discharged gas flow which is discharged out from collision portions of gas flows. An atomizing pattern is formed by the discharged gas flow. When liquid and the collision portion formed by collision of the two injected gas flows collide against each other, the atomizing pattern is formed into a wide fan shape formed around a liquid outflow direction axis, and its cross sectional shape is an oval shape or a long circular shape (see FIGS. 2A and 2B). In FIG. 2A, there is a tendency that mist 62 spreads into a fan shape in a direction perpendicularly intersecting with gas injection direction axes of the first and second gas injection portions 1 and 2. Collided gas (after collision) diffuses in parallel to a collision surface at which the gas flows collide against each other (in a direction in which the collision surface spreads), and the mist 62 is injected in this direction widely in the fan shape. In the present invention, a wide-angle injection angle γ is more than 80° or 100° to 180°.

As one embodiment of the invention, it is preferable that an intersection angle between an injection direction axis of the first gas injection portion and an injection direction axis of the second gas injection portion is in a range of 90° to 180°. An angle range where injection direction axes of the first and second gas injection portions 1 and 2 intersect corresponds to a collision angle of gas injected from the first gas injection portion 1 and gas injected from the second gas injection portion 2. For example, the “collision angle α” is 90° to 220°, preferably 90° to 180°, and more preferably 110° to 180°. FIG. 4 shows a collision angle α. When liquid is flowed out to a collision portion which forms a collision angle smaller than 180°, as the collision angle is smaller, it resembles a conventional two-fluid nozzle principle (gas and liquid are flowed out in the same injection direction and liquid is miniaturized by a shear effect generated by accompanying flow of gas and liquid). Therefore, there is a tendency that the effect of the miniaturization principle of the invention becomes low, but as the collision angle is smaller, there is a tendency that backflow of injected liquid is suppressed. When liquid is flowed out to a collision portion which forms a collision angle greater than 180°, as the collision angle is greater, there is a tendency that injected gas and gas which collides and widens function to push back flowed-out liquid to make the liquid flow backward. In FIG. 4, a tip end of the nozzle of the liquid outflow portion 6 is in contact with tip ends of both the nozzles of the gas injection portions 1, 2, but the invention is not limited to this configuration. A position of the tip end of the nozzle of the liquid outflow portion 6 may be disposed between both the nozzles of the gas injection portions 1, 2 or may be separated away from the gas injection portions 1, 2 as compared with the disposition shown in FIG. 4.

As one embodiment of the invention, FIG. 5 shows an example in which the outflow direction axis of liquid is inclined with respect to a collision face 100a of the collision portion 100. This inclination angle β is in a range of ±80° from 0° (intersection position), preferably in a range of ±45° from 0°, more preferably in a range of 30° from 0°, and more preferably in a range of ±15° from 0°. As the inclination angle β becomes smaller, there is a tendency that producing efficiency of mist is higher.

It is sufficient that an inclination angle of each of the restriction portions of the invention is smaller than 180°, for example, in an angle range of 10° to 160° so that the restriction portion is oriented in the spray direction. As a preferred embodiment, the restriction portion is preferably inclined in an angle range of 20° to 150°. FIG. 1D shows an inclination angle θ of the restriction portions 32a and 32b. The inclination angle θ is preferably in a range of 20° to 150°, more preferably in a range of 40° to 120°, and further preferably in a range of 60° to 90°. As θ becomes smaller, mist is sprayed more straightly, mist is less likely to adhere to a periphery of a spray outlet, but a long diameter of a spray pattern becomes shorter and the spray pattern does not become a wide angle spray pattern. On the other hand, as θ becomes greater, mist is likely to adhere to the periphery of the spray outlet, and the mist is likely to become dew. If θ is in a range of 60° to 90°, a suppressing effect of generation of dew is high and a wide angle spray pattern can be maintained. By controlling the inclination angle θ (=θ1+θ2) by the restriction portions of the present invention, it is possible to variably control a length of a long diameter of the spray pattern and to variably control the spray pattern. It is not always necessary that the restriction portions 32a and 32b are inclined by the same inclination angles (θ/2) from a center axis of the spray direction as shown in FIG. 1D, and the angles θ1 and θ2 may be different from each other in accordance with a desired spray pattern.

As one embodiment of the invention, it is preferable that the gas-liquid mixing area is formed closer to a spray direction than the bottom of the spray slit.

According to this configuration, the gas-liquid mixing area 120 (collision portion area between gas flows and liquid flow) is formed closer to the spray direction than a bottom (bottom surface) 31a of the spray slit 31 as shown in FIG. 1E. According to the conventional two-liquid nozzle, a maximum spray angle is less than 100°, and if a spray distance is not long, a spray pattern becomes a tapered pattern (if nozzle is used with spray angle of 100° or more, practical utility is greatly deteriorated), but according to the present invention, a tapered degree is small, and it is possible to easily obtain a spray pattern having a maximum spray angle (wide angle spray angle γ) of 180°. Further, by a high atomization effect obtained by an atomization principle of the present invention and low density of the spray pattern cross section obtained by the wide angle atomization of the present invention, it is possible to atomize with a low gas-liquid ratio which is significantly lower than that of the conventional two-liquid nozzle.

As one embodiment of the invention, it is preferable that a cross section of a tip end of the projection that projects out of the device is semi-circular or semi-elliptic.

According to this configuration, a cross section of a tip end 30a of each of the projections 30 has a rounded semi-circular or semi-elliptic shape as shown in FIGS. 1C, 1F, and 2C. Accordingly, a density distribution of particles in the long diameter direction of the spray pattern can be substantially equalized, and the cross section of the tip end 30a is rounded, whereby it is possible to control the density distribution of mist particles in the long diameter direction of the spray pattern. On the other hand, if a tip end 30b is angular as shown in FIG. 2D, when mist passing through the tip end 30b expands, mist particles are caught on the tip end 30b (mist particles are easily caught since accessible area is large). Thus, streaks and coarse particles are likely to be generated in the spray pattern, and density of mist particles at a central portion of the spray pattern is likely to be higher than those of other areas.

As one embodiment of the present invention, a slit width (d1) of the first gas spray unit and a slit width (d2) of the second gas spray unit are preferably 1 to 1.5 times of an outlet orifice diameter (d3) of the liquid outflow unit. This is because, when outflowing liquid and the collision portions or the collision walls of gas flows are caused to collide against each other, a collision cross sectional area of liquid is smaller than the collision portions or the collision walls. If the collision cross section of outflowing liquid is greater than the collision portions or the collision walls of gas flows, there is a tendency that a portion of liquid does not collide against the collision portions or the collision walls and is not atomized, and thus atomization is poor.

According to this configuration, as shown in FIG. 1F, the slit width of the first gas spray unit is d1, the slit width of the second gas spray unit (not shown) is d2, and d1 is equal to d2. When the outlet orifice diameter of the liquid outflow unit 6 is d3, d3 is in a range of d1 to 1.5×d1. Accordingly, uniform particle diameters and a uniform dispersion distribution can be obtained. If the slit width d1 of the gas spray unit is excessively larger than the outlet orifice diameter d3 of the liquid outflow unit, the atomization of a central portion of the spray pattern is deteriorated and coarse particles are likely to be generated. On the other hand, if the slit width d1 of the gas spray unit is excessively smaller than the outlet orifice diameter d3 of the liquid outflow unit, a large number of coarse particles are likely to be generated on both sides of the spray pattern in the long diameter direction.

Orifice diameters (diameters of cross section circles) of the first and second gas spray units are preferably in a range of 1 to 1.5 times of an orifice diameter (diameter of cross section circle) of the liquid outflow unit. This is due to the same reason as that described above.

As one embodiment of the present invention, a width (d4) of a projection is preferably greater than one time and six times or less of the slit width (d1) of the first gas spray unit and the slit width (d2) of the second gas spray unit, and more preferably 1.5 times or more and four times or less, and further preferably two times or more and three times or less. As the width d4 becomes greater, an area which comes into contact with mist becomes greater, and dew is generated more easily.

As shown in FIG. 1E, a width (d5) and a slit depth (d6) of a spray slit formed in the projection are not particularly limited, but the spray slit preferably has a space to an extent that a gas-liquid mixing area 120 can be disposed therein.

As one embodiment of the invention, it is preferable that the liquid flow is of continuous flow, intermittent flow or impulse flow. The continuous flow is columnar liquid flow. The intermittent flow is liquid flow injecting at predetermined intervals. The impulse flow is liquid flow injecting instantaneously at predetermined timing. By controlling an injection method of liquid at will by a liquid supply device or the like, it is possible to control atomizing timing and an atomizing amount of mist at will.

As one embodiment of the invention, the liquid is miniaturized liquid. As liquid injected from the liquid injection portion, it is possible to use miniaturized liquid minute particle, and an example of the liquid minute particle is liquid minute particle which is miniaturized by a two-fluid nozzle device, an ultrasound device, an extra-high voltage atomizer, a steaming type atomizer and the like.

The gas is not especially limited, but examples of the gas are air, clean air, nitrogen, inert gas, fuel mixture air and oxygen, and it is possible to appropriately set gas in accordance with intended use.

The liquid is not especially limited, but examples of the liquid are water, ionized water, cosmetic medicinal solution such as skin lotion, medicinal solution, bactericidal solution, medicinal solution such as sterilization solution, paint, fuel oil, coating agent, solvent and resin.

### BRIEF DESCRIPTION OF THE DRAWINGS

FIG. 1A is a schematic view for describing one example of a liquid atomization device.

FIG. 1B is a schematic view for describing one example of a liquid atomization device.

FIG. 1C is a schematic view for describing one example of a liquid atomization device.

FIG. 1D is a schematic view for describing one example of a liquid atomization device.

FIG. 1E is a schematic view for describing one example of a liquid atomization device.

FIG. 1F is a schematic view for describing one example of a liquid atomization device.

FIG. 2A is a schematic view of a spray outlet of the liquid atomization device seen from above.

FIG. 2B is a schematic view of the liquid atomization device seen from the side.

FIG. 2C is a schematic view for describing a spray pattern example.

FIG. 2D is a schematic view for describing a spray pattern example.

FIG. 3A is a schematic view of a relative placement example between a liquid outflow unit and gas spray units.

FIG. 3B is a schematic view of a relative placement example between a liquid outflow unit and gas spray units.

FIG. 3C is a schematic view of a relative placement example between a liquid outflow unit and gas spray units.

FIG. 3D is a schematic view of a relative placement example between a liquid outflow unit and gas spray units.

FIG. 3E is a schematic view of a relative placement example between a liquid outflow unit and gas spray units.

FIG. 3F is a schematic view of a relative placement example between a liquid outflow unit and gas spray units.

FIG. 4 is a schematic view for describing an intersection angle formed between two gas spray axes.

FIG. 5 is a schematic view for describing inclination of a liquid outflow direction.

FIG. 6A is a perspective view of an outer appearance of a liquid atomization device of a first embodiment.

FIG. 6B is a partially schematic sectional view of the liquid atomization device in FIG. 6A.

FIG. 6C is a schematic front view of the liquid atomization device in FIG. 6B.

FIG. 6D is an enlarged view of a portion A of the liquid atomization device in FIG. 6A.

FIG. 7A is a partially schematic sectional view of an outer cap portion which constitutes a gas orifice in FIG. 6A.

FIG. 7B is a front schematic view of the outer cap portion in FIG. 7A.

FIG. 7C is a schematic back view of the outer cap portion in FIG. 7A.

FIG. 7D is a schematic sectional view of the outer cap portion in FIG. 7B taken along line X-X.

FIG. 7E is an enlarged view of a portion A of the outer cap portion in FIG. 7A.

FIG. 7F is an enlarged view of a portion C of the outer cap portion in FIG. 7D.

FIG. 7G is a schematic sectional view of the outer cap portion in FIG. 7E taken along line B-B.

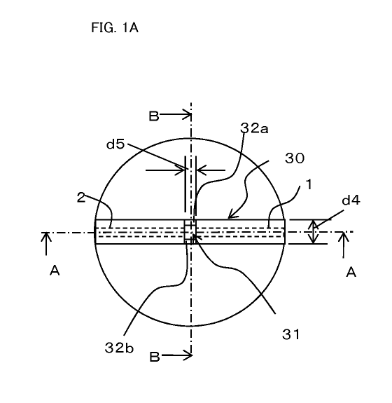

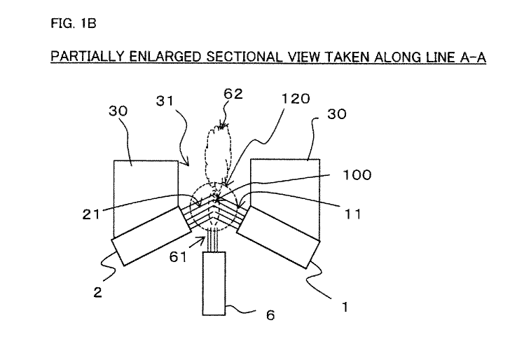

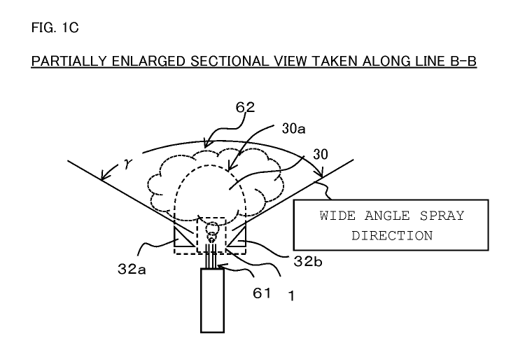

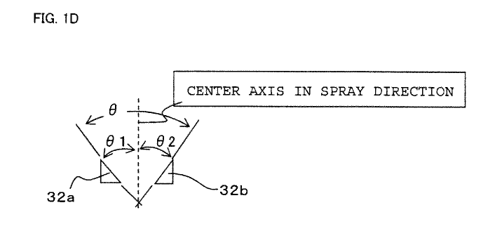

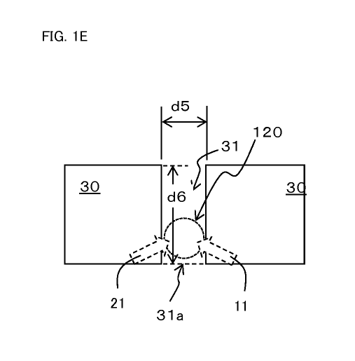

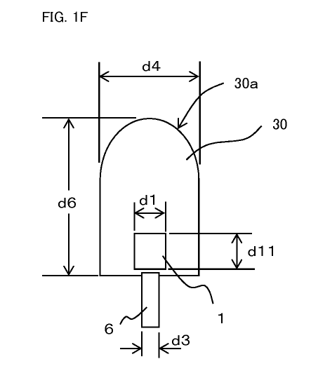

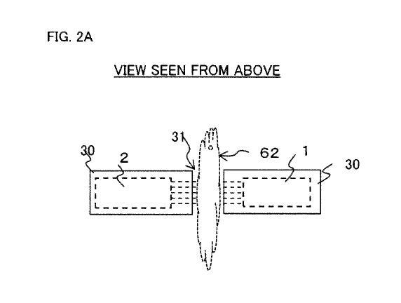

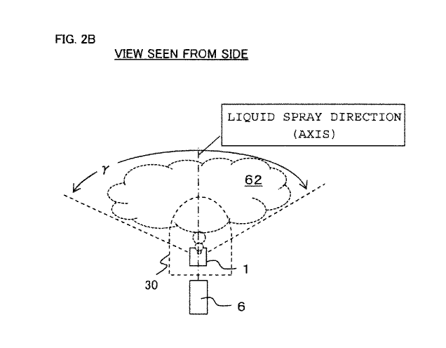

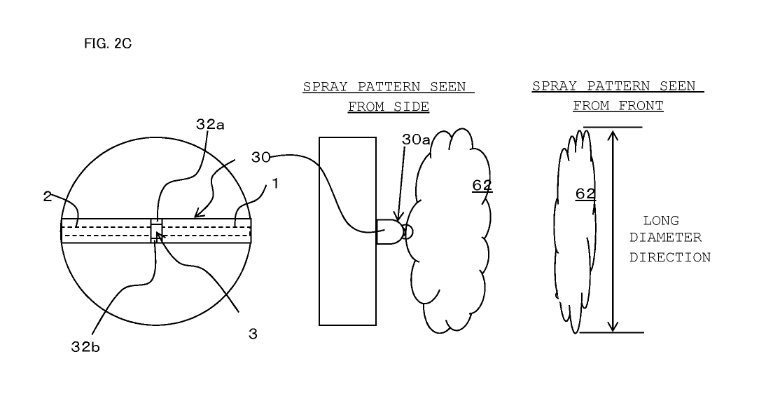

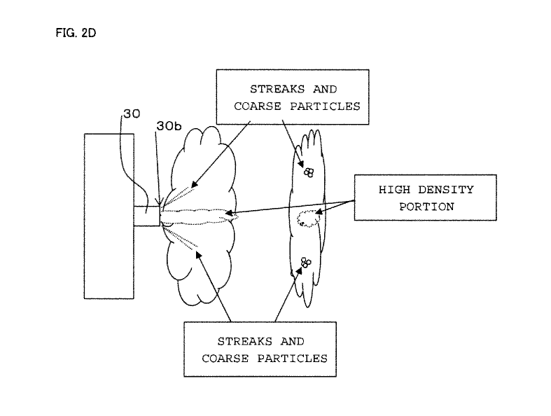

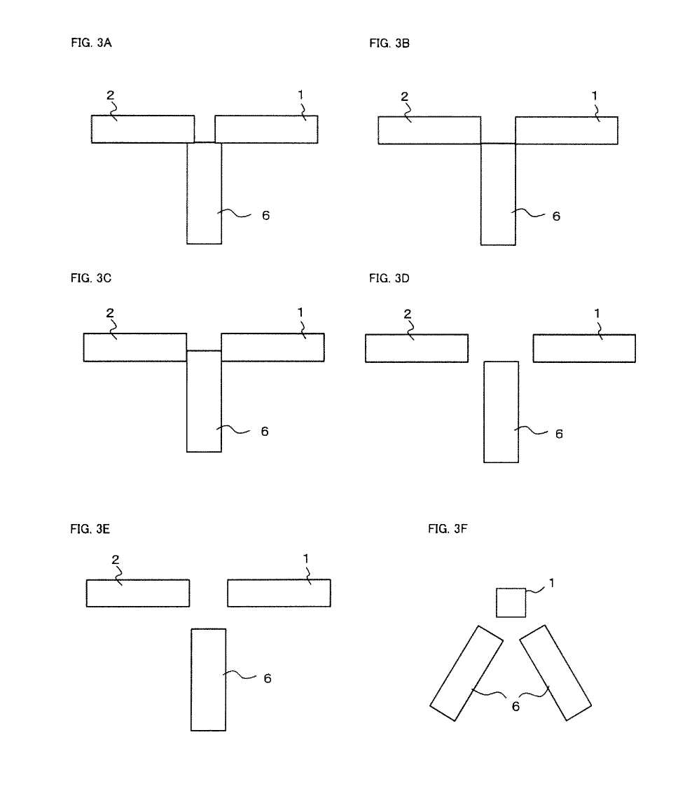

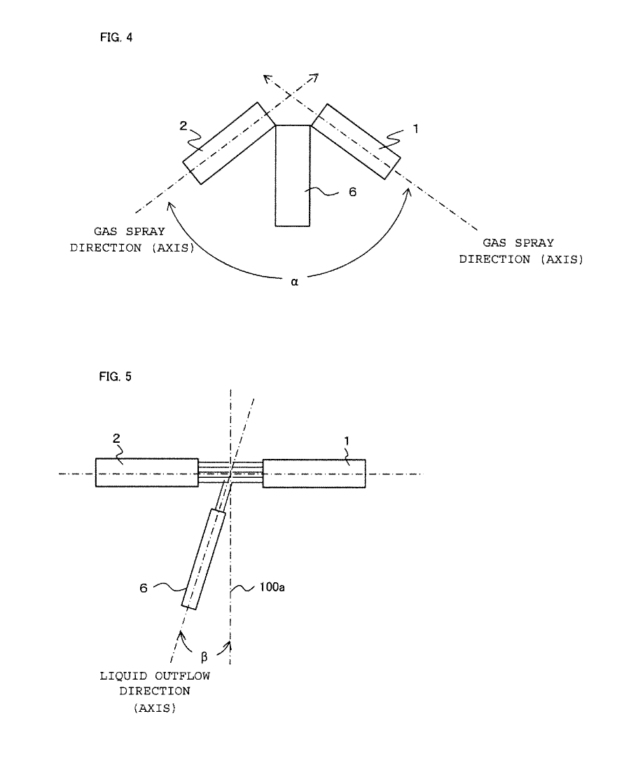

### MODE FOR CARRYING OUT THE INVENTION

### First Embodiment

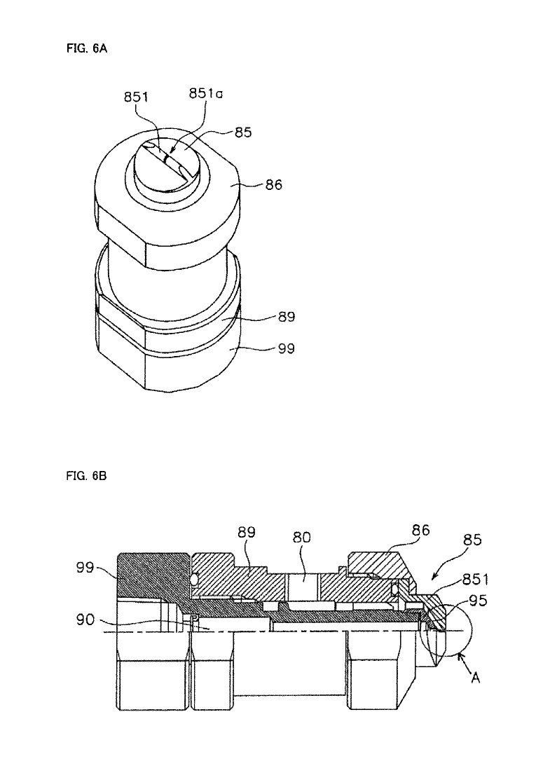

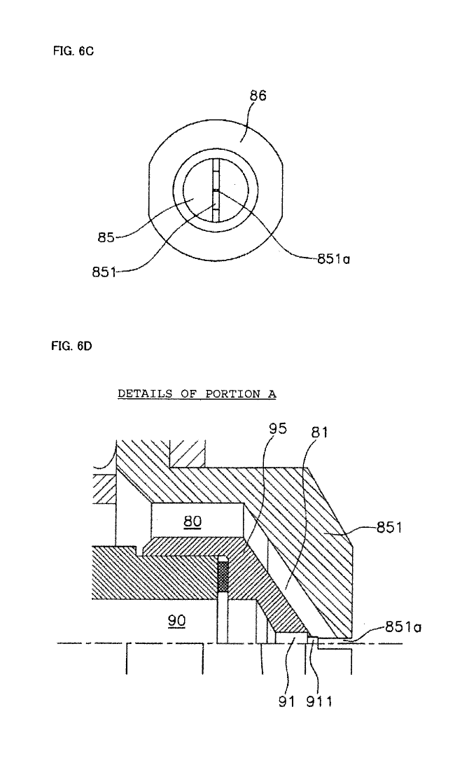

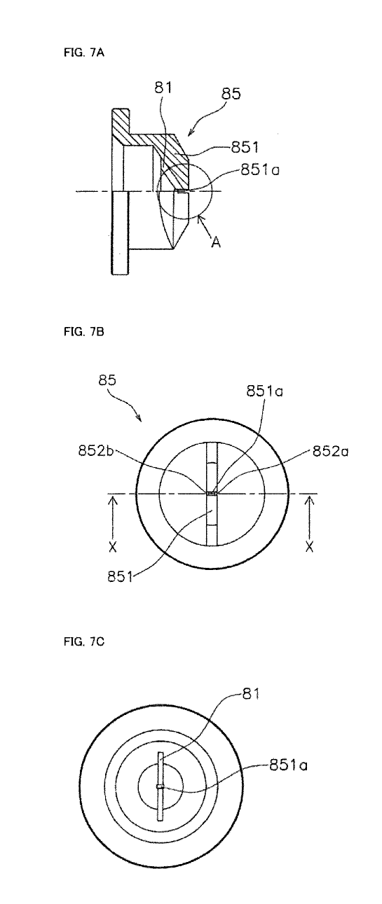

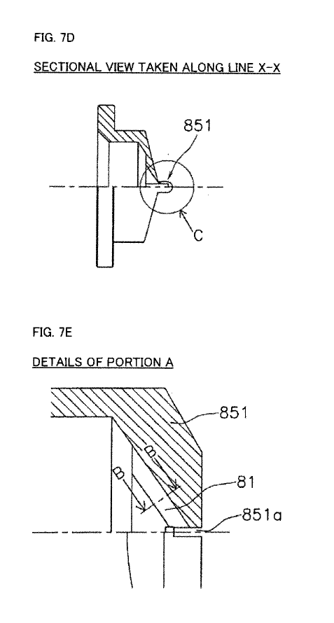

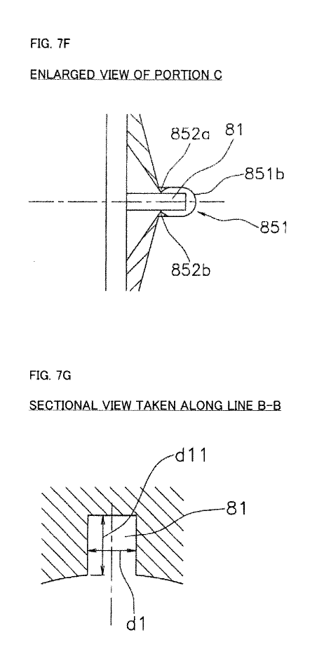

A liquid atomization device of a first embodiment will be described with reference to FIGS. 6A to 6D. The liquid atomization device shown in FIGS. 6A to 6D is configured as a nozzle device. FIGS. 7A to 7G are views for describing an outer cap portion. A first gas orifice 81 constituting a first gas spray unit and a second gas orifice (not shown) constituting a second gas spray unit are disposed so as to cause gas flows to collide against each other with a collision angle (α)=110°. Their orifice cross sections are square.

As shown in FIG. 6B, gas is supplied from a gas passage 80. The gas passage 80 is connected to a compressor (not shown). By controlling the compressor, a spray amount and spray speed of gas can be set. The gas passage 80 is in communication with both the first gas orifice 81 and second gas orifice. Spray amounts and spray speeds (flowing speeds) of gases sprayed from the first gas orifice 81 and the second gas orifice are set equal to (or substantially equal to) each other.

Liquid is supplied from a liquid passage 90. The liquid passage 90 is connected to a liquid supply unit (not shown). The liquid supply unit pressurizes liquid and sends liquid to the liquid passage 90. The liquid supply unit sets a liquid sending amount and liquid sending speed of liquid. The liquid passage 90 is formed in a nozzle interior body 99. The gas passage 80 is formed by a nozzle exterior body 89 which is fixed to and incorporated in an outer wall of the nozzle interior body 99 with a screw.

An inner cap portion 95 is incorporated in a tip end of the nozzle interior body 99. A liquid orifice 91 for flowing out liquid supplied from the liquid passage 90 is formed by the inner cap portion 95. It is preferable that a cross section of the liquid orifice 91 is circular. In this embodiment, the liquid orifice 91 extends straightly in a long axis direction thereof, and a diameter of a tip end 911 of the liquid orifice 91 is smaller than other orifice diameter.

An outer cap portion 85 is incorporated in a tip end of the nozzle exterior body 89. By fixing a screwing portion 86 to the nozzle exterior body 89 with a screw, the outer cap portion 85 which is in direct contact with the screwing portion 86 and the inner cap portion 95 which is pressed by the outer cap portion 85 are fixed. The first gas orifice 81 and the second gas orifice (not shown) form a recessed groove having a rectangular cross section in an inner wall surface of the outer cap portion 85 (see sectional views in FIGS. 7E and 7G taken along line B-B). By tightly sealing the recessed groove by the inner cap portion 95, the first gas orifice 81 and the second gas orifice (not shown) having rectangular cross sections are formed. The recessed groove 81 has a slit width d1 and a slit depth d11. The fixing method of these members is not limited to the screw fixing, and other connecting means can be used. A seal member (e.g., O-ring) (not shown) may appropriately be incorporated in a gap between the members.

As shown in FIGS. 7A to 7D, a projection 851 is formed on the outer cap portion 85 outside the device such that a cross section thereof projects in a convex manner. A gas-liquid mixing area (not shown) is formed in the projection 851. A spray slit 851a is formed in the projection 851. As shown in FIG. 7F, restriction portions 852a and 852b are formed in the vicinity of a bottom of the spray slit 851a along a wide angle spray direction. In this embodiment, an inclination angle (θ) formed between the restriction portions 852a and 852b is 60°. By these restriction portions 852a and 852b, sprayed mist does not adhere to a nozzle tip end surface and is likely to be sprayed forward, dew is less likely to generate on the nozzle tip end surface even if the inclination angle is wide, and average particle diameters in the spray pattern long diameter direction are substantially equalized. Note that the inclination angle θ is not limited to 60°.

As shown in FIG. 7F, a tip end cross section 851b of the projection 851 is semi-circular. Accordingly, a density distribution of particles in the long diameter direction of the spray pattern can be substantially equalized, and since the tip end cross section is rounded, it is possible to suitably control the density distribution of the mist particles in the long diameter direction of the spray pattern.

The gas-liquid mixing area (not shown), which is an area where two gas flows and one liquid flow collide against each other, is formed closer to the spray direction than a bottom of the spray slit 851a. Accordingly, a tapered degree is small, and it is possible to easily obtain a spray pattern having a maximum inclination angle (wide angle spray angle γ) of 180°.

Although the outer cap portion 85 and the inner cap portion 95 form the first and second gas orifices in the first embodiment, the first and second gas orifices may be formed by one member. Cross sectional shapes of the first and second gas orifices are not limited to the rectangular shapes, and other polygonal shapes may be employed or circular shapes may be employed. The collision angle α between the gas flows is not limited to 110°, and the angle may be set within a range of 90° to 180°.

### Example 1

Using the liquid atomization device having the configuration shown in the first embodiment, presence or absence of generation of dew was evaluated. Each of the spray slit 851a of the projection 851 in Example 1 had a width (d4) of 1 mm, a slit depth (d6) of 0.95 mm, a slit interval (d5) of 0.3 mm, an inclination angle θ of the restriction portions 852a and 852b was 60°, a rectangular cross section of each of the first and second gas orifices had a slit width (d1) of 0.47 mm, a slit depth (d11) of 0.57 mm, and a diameter of a cross section of the liquid orifice tip end was φ0.35 mm. Air was used as gas, and water was used as liquid. Air pressure Pa, water pressure Pw, a spray angle, average particle diameters (SMD), and an amount of dew were evaluated based on the following two cases: when an air amount Qa of gas spray was 10.0 (NL/min), a spray (water) amount Qw was 25.0 (ml/min), and when an air amount Qa of gas spray was 10.0 (NL/min), a spray (water) amount Qw was 50.0 (ml/min). The results are shown in Table 1. It was confirmed that dew was not generated in any of these cases. In Example 1, on the other hand, the same evaluation was conducted based on Comparative Example 1 having no restriction portions 852a and 852b, and it was confirmed that dew was generated.

TABLE 1

| | | | | | | Average | |
|---|---|---|---|---|---|---|---|
| | | Water | Air | Spray | | particle | |
| | Air | pressure | amount | amount | | diameter | |
| Restriction | pressure | Pw | Qa | Qw | Spray | SMD | Dew |
| member | Pa (MPa) | (MPa) | (NL/min) | (ml/min) | angle | (μm) | generation |
| Example 1 | 0.190 | 0.128 | 10.0 | 25.0 | 110.0 | 8.75 | Absence |
| Condition 1 | | | | | | | |
| (Presence) | | | | | | | |
| Example 1 | 0.206 | 0.188 | 10.0 | 50.0 | 120.0 | 9.87 | Absence |
| Condition 2 | | | | | | | |
| (Presence) | | | | | | | |
| Comparative | 0.190 | 0.128 | 10.0 | 25.0 | 110.0 | 8.75 | Presence |
| Example 1 | | | | | | | |
| Condition 1 | | | | | | | |
| (Absence) | | | | | | | |
| Comparative | 0.206 | 0.188 | 10.0 | 50.0 | 120.0 | 9.87 | Presence |
| Example 1 | | | | | | | |
| Condition 2 | | | | | | | |
| (absence) | | | | | | | |

### Example 2

In Example 1, the inclination angle of each of the restriction portions 852a and 852b was set to 90°, the air amount Qa of gas spray was set to 10.0 (NL/min) and the spray (water) amount Qw was set to 50.0 (ml/min). Under this condition, air pressure Pa, water pressure Pw, and average particle diameters (SMD) at a central portion and both ends of the spray pattern in the long diameter direction were evaluated. As comparison, the same evaluation was conducted without the restriction portions 852a and 852b (Comparative Example 2). The results are shown in Table 2. In Example 2, the average particle diameters of mist at the central portion and the both ends of the spray pattern in the long diameter direction were substantially equal to each other. In Comparative Example 2, on the other hand, the average particle diameter of mist on the both ends of the spray pattern in the long diameter direction was apparently greater. It was confirmed that, by providing the restriction portions 852a and 852b, the average particle diameters of mist of the spray pattern in the long diameter direction are substantially equalized.

TABLE 2

| | | | | | SMD (μm) at | |
|---|---|---|---|---|---|---|
| | | | | | central portion | SMD (μm) at |
| | | | Air | Spray | of spray | end of spray |
| | Air | Water | amount | amount | pattern in long | pattern in |
| | pressure | pressure | Qa | Qw | diameter | long diameter |
| | Pa (MPa) | Pw (MPa) | (NL/min) | (ml/min) | direction | direction |
| Example 2 | 0.182 | 0.165 | 10.0 | 50.0 | 12.75 | 12.71 |
| Comparative | 0.207 | 0.170 | 10.0 | 50.0 | 11.36 | 16.82 |
| Example 2 | | | | | | |
| (No | | | | | | |
| restriction | | | | | | |
| portion) | | | | | | |

### Example 3

### Evaluation of Density Distribution of Spray Pattern

In Example 1, the tip end cross section 851b of the projection 851 is semi-circular (described in Table 3 as Example 3). As comparison, a projection having an angular tip end, i.e., having a rectangular tip end was evaluated (Comparative Example 3). The results are shown in Table 3. In Example 3, it was confirmed that a density distribution of mist particles was substantially equalized in the long diameter direction of the spray pattern. In Comparative Example 3, on the other hand, it was confirmed that a high density area and a low density area of mist particles were separated in the long diameter direction of the spray pattern as shown in FIG. 2D.

TABLE 3

| | | | | Spray | | Average |
|---|---|---|---|---|---|---|
| | Air | Water | Air | amount | | particle |
| | pressure | pressure | amount Qa | Qw | Spray | diameter |
| | Pa (MPa) | Pw (MPa) | (NL/min) | (ml/min) | angle | SMD (μm) |
| Example 3 | 0.206 | 0.188 | 10.0 | 50.0 | 120.0 | 9.87 |
| (Semi-circular) | | | | | | |
| Comparative | 0.205 | 0.210 | 10.0 | 50.0 | 140.0 | 11.63 |
| Example 3 | | | | | | |
| (Rectangular) | | | | | | |

### Example 4

Next, a tip end diameter of a liquid orifice was fixed to φ=0.35 mm, a size of a rectangular cross section of a gas orifice was changed, an air amount Qa of gas spray was set to 10.0 (NL/min), and a spray (water) amount Qw was set to 50.0 (ml/min). Under this condition, air pressure Pa, water pressure Pw, and average particle diameters (SMD) at a central portion and both ends A and B of the spray pattern in the long diameter direction were evaluated (Comparative Examples 4 and 5). The results are shown in Table 4. In Example 4 (slit width was 1.35 times of tip end diameter of liquid orifice), particle diameters at the central portion and the both ends A and B were substantially uniform in the long diameter direction of the spray pattern, and atomization was substantially uniform. On the other hand, in Comparative Example 4 (rectangular cross section size of gas orifice was excessively large, and slit width was 2.24 times of tip end diameter of liquid orifice), average particle diameters at the central portion were two times or more of those at the both ends of the spray pattern in the long diameter direction, and the atomization effect of liquid was low. It is assumed that this is because the evaluation was conducted under a condition that the air amount and the spray amount were constant and therefore, air density in the collision wall of the two gas flows was lower than that of Example 4, and liquid was sprayed forward before atomization of liquid progressed. In Comparative Example 5 (rectangular cross section size of gas orifice was excessively small, and slit width was 0.85 times of tip end diameter of liquid orifice), the average particle diameters at the central portion was about two times smaller than those at the both ends of the spray pattern in the long diameter direction, and the atomization effect of liquid was low. It is assumed that this is because a cross sectional area of liquid which collides against the collision walls of the two gas flows was greater than those of the collision walls and therefore, collision against gas flows was reduced toward a diameter direction of the liquid flow.

TABLE 4

| | | | | | | SMD (μm) at | | |
|---|---|---|---|---|---|---|---|---|
| | | | | | | central portion | SMD (μm) at | SMD (μm) at |
| | Rectangular | | | | Spray | in long | end A in long | end B in long |
| | cross section of | Air | Water | Air | amount | diameter | diameter | diameter |
| | gas orifice | pressure | pressure | amount Qa | Qw | direction of | direction of | direction of |
| | (Width × Depth) | Pa (MPa) | Pw (MPa) | (NL/min) | (ml/min) | spray pattern | spray pattern | spray pattern |
| Example 4 | 0.473 × 0.682 | 0.142 | 0.166 | 10.0 | 50.0 | 15.98 | 11.71 | 15.09 |
| Comparative | 0.785 × 0.516 | 0.145 | 0.185 | 10.0 | 50.0 | 29.03 | 11.44 | 9.36 |
| Example 4 | | | | | | | | |
| Comparative | 0.300 × 0.480 | 0.550 | 0.238 | 10.0 | 50.0 | 16.70 | 25.28 | 37.25 |
| Example 5 | | | | | | | | |

In the above description, the average particle diameters (SMD) were measured by a measuring device of a laser diffraction method. A measuring position was on a spray direction axis and at a position of 150 mm from a nozzle tip end.

### DESCRIPTION OF REFERENCE SIGNS

1 first gas spray unit (first gas orifice)
2 second gas spray unit (second gas orifice)
6 liquid outflow unit (liquid orifice)
30 projection
31 spray slit
32a, 32b restriction portion
62 mist
81 first gas orifice
85 outer cap portion
851 projection
851a spray slit
851b tip end cross section
852a, 852b restriction portion
91 liquid orifice
100 collision portion
100a collision surface
120 gas-liquid mixing area

1. A liquid atomization device comprising:
a first gas spray unit and a second gas spray unit for causing two gas flows collide against each other;
a liquid outflow unit for flowing out liquid;
a gas-liquid mixing area where a gas flow sprayed from the first gas spray unit, a gas flow sprayed from the second gas spray unit, and liquid which flows out from the liquid outflow unit are made to collide against each other to atomize the liquid;
a projection formed to project out of the device such that its cross section projects in a convex manner, the gas-liquid mixing area being formed in the projection;
a spray slit formed in the projection along a wide angle spray direction of mist produced by the gas-liquid mixing area; and
a restriction portion formed near a bottom of the spray slit such that the restriction portion inclines in the wide angle spray direction of the mist.

2. The liquid atomization device according to claim 1, wherein the restriction portion is formed to incline in an angle range of 20° to 150°.

3. The liquid atomization device according to claim 1 or 2, wherein the gas-liquid mixing area is formed distance position toward a spray direction than the bottom of the spray slit.

4. The liquid atomization device according to claim 1 or 2, wherein a cross section of a tip end of the projection that projects out of the device is semi-circular or semi-elliptic.

5. The liquid atomization device according to claim 1, wherein a slit width (d1) of the first gas spray unit and a slit width (d2) of the second gas spray unit are 1 to 1.5 times of a diameter (d3) of an outlet orifice of the liquid outflow unit.
